(19) United States
(12) Patent Application Publication
(10) Pub. No.: US 2004/0059924 A1
(43) Pub. Date: Mar. 25, 2004

(54) Biometric private key infrastructure

(75) Inventors: Luz Maria Soto, Orlando, FL (US); Michael L. Hankinson, Pine, CO (US); Roger D. Pirkey, Hudson, FL (US)

Correspondence Address: Pillsbury Winthrop LLP, Intellectual Property Group, 1600 Tysons Boulevard, McLean, VA, 22102, US

(73) Assignee: Aurora Wireless Technologies, Ltd.

(21) Appl. No.: 10/612,715

(22) Filed: Jul. 1, 2003

Related U.S. Application Data
(60) Provisional application No. 60/393,606, filed on Jul. 3, 2002.

(51) Int. Cl. H04L 9/32; H04L 9/00

(52) U.S. Cl. 713/186; 713/176; 713/202

(57) ABSTRACT

In accordance with an aspect of providing trust and authentication for network communications and transactions, a network infrastructure is provided that employs biometric private keys (BioPKI). Generally, Bio PKI is a unique combination of two software solutions that validate electronic user authentication: a state-of-the-art biometric signature system, and a digital signature for data integrity. The combined solution allows networked businesses and merchants such as financial institutions to ensure that user authentication is conducted in a trusted, secure fashion within standard network environments. In one example implementation, a biometric signature augments standard digital signatures by adding an automated, non-reputable user authentication capability to the existing digital signature process. In contrast to simple verification in a pure biometric-based system or digital signature/certificate environment, BioPKI uses a combination of biometric technology to access private keys in order to create digital signatures based on biometric authentication and industry-standard PKI technologies. In one example, BioPKI utilizes public key cryptography technology to encrypt the biometric signature information for transmission to the BioPKI server. The encryption packet contains several layers of internal information to ensure that the biometric signature is secured and validated prior to accessing the individual's private key.

### CROSS-REFERENCE TO RELATED APPLICATIONS

This application claims priority to U.S. provisional patent application Serial No. 60/393,606, filed Jul. 3, 2002, which application is incorporated herein by reference for all purposes.

### FIELD OF THE INVENTION

The present invention relates generally to network communications and transactions, and more particularly, to trust and verification of network communications and transactions using a private key infrastructure employing biometric authentication.

### BACKGROUND OF THE INVENTION

The Internet is well on the way to becoming the primary platform for global commerce and communications. This is now a networked world, filled with computers and electronic networks with no sense of dimensions. In the business world, head offices, financial institutions, etc. communicate and share sensitive information, which all contribute to the skyrocketing increase in Internet usage. Businesses, governments, and individuals rely heavily on the new technologies to conduct business on a daily basis. Adults, children, etc rely on e-mails to communicate with friends, peers, and loved ones in the comfort of their homes by accessing the Internet.

Closer and closer everyday to realizing the full potential of the Internet and other networks, persons now engage in financial transactions with the same degree of trust associated with paper-based transactions and point of presence. Sealed envelopes, official stationery, written signatures, ID Verification and trusted delivery services provide confidence in traditional communications. In the network, electronic transactions are conducted in a “virtual world.”

The very openness that has encouraged the Internet's explosive growth, however, also makes it difficult to ensure that Internet transactions are secure, both in context, form and user identity. Governments, businesses and individuals demand mechanisms that not only will guarantee the integrity of the information they transmit over the Internet, but also the comfort that the protected information was truly sent by the identifying person, thus providing the same level of trust as paper-based transactions and identification verifications as those done in person.

Before committing their sensitive communications to the Internet, users therefore require specific assurances. They want their electronic transactions to be confidential and protected from tampering. They want to be able to trust that participants are who they claim to be, and they want to be assured that no one can deny their involvement in a transaction after the fact.

Public key cryptography and public key infrastructures (PKI) are known methods for providing secured on-line transactions in network environments. As is known, public key cryptography includes the use of asymmetric public keys and private keys (i.e. key pairs). An example framework for implementation of public key cryptography is set forth in the public domain Public-Key Cryptography Standards (PKCS), provided by RSA Security, Inc. Version 2.1 (June, 2002) of the standard is available at www.rsasecurity.com/rsalabs/pkcs/pkcs1/index.html, the contents of which are incorporated herein by reference.

PKI may further include the use of digital certificates and certification authorities. An example of a conventional PKI 100 is illustrated in FIG. 1. As shown in FIG. 1, when a sender 102 wishes to send a trusted message to recipient 104 (e.g. for a secure transaction), sender 102 applies for a key pair from certificate authority 106. Certificate authority (CA) 106 creates a key pair comprising a private key 108 and a public key 110 for sender 102. The CA further issues an encrypted digital certificate 114 containing the sender's public key and a variety of other identification information. The CA makes its own public key 112 available through, for example, print publicity or on the Internet. The intended recipient 104 can then use the CA's public key 112 to decode the digital certificate and verify that it was issued by the CA 106. With this information, the recipient can then obtain the sender's public key 110 and use it to send an encrypted reply back to sender 102. A message from sender 102 to recipient 104, whether encrypted or not, can also include a digital signature for further verification. As is known, the digital signature is generated from the message itself using the sender's private key 108, verifying that the signature belongs to this particular message, and thus assuring that the contents of the message have not been tampered with. Using sender's public key 110, the recipient 108 can thus decode the digital signature and perform such additional verification. It should be noted that the terms “sender” and “recipient” are used here for ease of illustration. Those skilled in the art will understand that a particular “sender” in one transaction can also receive messages, whether encrypted or not, while a particular “recipient” can also send messages for the same or different transaction.

The conventional PKI 100 thus attempts to ensure that sensitive electronic communications are private and protected from tampering. It provides' some assurances that the contents of the original message have not been tampered with and can be verified by the receiving entity.

Governments, businesses and individuals eager to participate in the digital revolution are all prospective users of digital certificates. Given the potential numbers of certificates this would involve, a way is needed to administer and manage their use. Certificate management is a gauge of the strength of a PKI's certification authority. Around the world, enterprises large and small are adopting Public Key Infrastructures as their preferred solution for enabling the centralized creation, distribution, management, renewal and revocation of certificates.

However, problems remain. The premise behind the current transaction security systems on the Internet is that the legitimate user possesses something known (the private key), or has been entrusted with a password or token which decrypts the user's private key, or grants access to it through the use of conventional encryption techniques. This private key can be embedded in the contents of a digital certificate (in the case of a web browser), or can be encrypted in handheld or computer devices, such as Smart Cards or other electronic devices. In all of these scenarios, the assumption is that the user protects these devices and keys from theft through personal possession and safeguarding. However, in today's network environment, these tokens can be easily compromised by careless control by the user, or by direct theft or password manipulation.

Co-pending U.S. application Ser. No. 09/801,468 (AWT-003), commonly owned by the present assignee, the contents of which are incorporated herein by reference, dramatically advanced the state of the art of reducing fraud in connection with on-line transactions using biometrics. A need remains, however, to more fully extend certain of the biometric user authentication aspects of that invention to on-line communications and commerce transactions within standard network environments so as to address even further problems in the art such as those mentioned above.

### SUMMARY OF THE INVENTION

The present invention relates generally to trust and authentication for network communications and transactions. In accordance with an aspect of the invention, a network infrastructure is provided that employs biometric private keys (BioPKI). Generally, Bio PKI is a unique combination of two software solutions that validate electronic user authentication: a state-of-the-art biometric signature system, and a digital signature for data integrity. The combined solution allows networked businesses and merchants such as financial institutions to ensure that user authentication is conducted in a trusted, secure fashion within standard network environments. This new technology provides both user authentication and data integrity in a world of electronic communications.

In one example implementation, a biometric signature augments standard digital signatures by adding an automated, non-reputable user authentication capability to the existing digital signature process. In contrast to simple verification in a pure biometric-based system or digital signature/certificate environment, BioPKI uses a combination of biometric technology to access private keys in order to create digital signatures based on biometric authentication and industry-standard PKI technologies. In one example, BioPKI utilizes public key cryptography technology to encrypt the biometric signature information for transmission to the BioPKI server. The encryption packet contains several layers of internal information to ensure that the biometric signature is secured and validated prior to accessing the individual's private key.

According to another aspect of the invention, the system includes a client/server design that enables BioPKI to work seamlessly in a network environment. In one possible example, the system features a distributed architecture to rapidly authenticate individuals that are normally authenticated using simple four digit PIN/Token techniques that secure the individual's private key (such as smart cards). The BioPKI authentication server has access to biometric templates required to authenticate an individual before accessing the user's own private key, and the processing capacity to route digital signatures to appropriate downstream entities for transaction processing. This includes entities such as payment gateways, financial institutions, or other authentication brokers. BioPKI deploys biometrics user authentication as well as private key infrastructure technologies. By marrying these two technologies together, a more robust “Wireless PKI” security system is created, which does not require individuals to maintain multiple tokens; rather, this approach allows those private key(s) to be stored on a secure server that is accessed only after a biometric signature has been validated (for example a fingerprint). BioPKI can also be implemented using an additional password element for user authentication, that may or may not require the additional security of a biometric signature. This latter technique allows users of the system the ability to determine the level of security they desire for target transaction processing.

The BioPKI server and hosts are connected by various secured network methods to form a client/server architecture. The server and clients each contain discrete subsystems, which provide various levels of authentication services to users of the network. In one example of the invention, the system is comprised of user client(s), a network-based server, and industry standard encryption components that ensure trusted transport of user data. The current implementation includes strong encryption via SSL.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating a conventional public key infrastructure;

FIG. 2 is a block diagram illustrating a network infrastructure employing biometric authentication (Bio PKI) in accordance with the invention;

FIG. 3 is a block diagram illustrating an example implementation of a PKdI server that can be used in an infrastructure according to the invention;

FIG. 4 is a block diagram illustrating an alternative example implementation of a PKdI server that can be used in an infrastructure according to the invention;

FIG. 5 is a flowchart illustrating an example method implemented by an enrollment process according to one aspect of the invention;

FIG. 6 is a flowchart illustrating an example method implemented by a registration process according to one aspect of the invention;

FIG. 7 is a flowchart illustrating an example method implemented by a login process according to one aspect of the invention; and

FIG. 8 is a flowchart illustrating an example method implemented by a confirmation process according to one aspect of the invention.

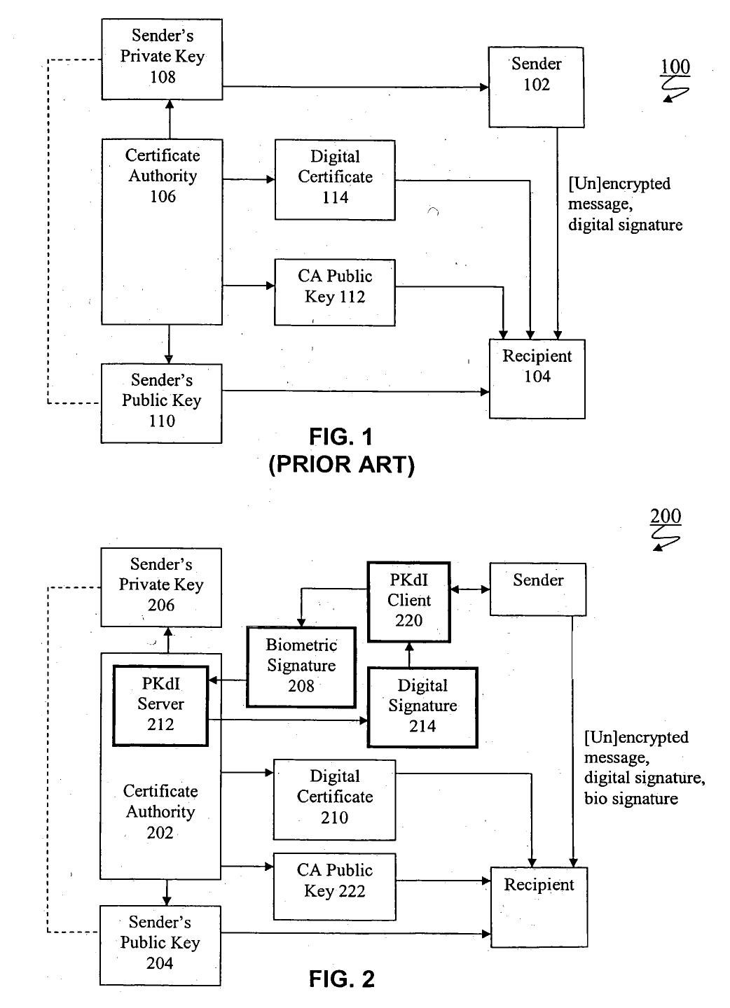

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Further, the implementation of certain components using hardware and certain other components using software is considered a design choice within those of skill in the art and the combination thereof described herein is intended to be illustrative rather than limiting. Still further, the present invention encompasses present and future known equivalents to the known components referred to herein by way of illustration, and implementations including such equivalents are to be considered alternative embodiments of the invention.

FIG. 2 is a block diagram illustrating an example implementation of a biometric private key infrastructure (Bio PKI) 200 in accordance with an aspect of the invention.

Generally, based on the use of public key cryptography, digital signatures and biometric characterization, BioPKI provides assurances that users need to confidently transmit sensitive information over the Internet and other networks. In accordance with an aspect of the invention, authentication is based upon requiring biometric signature(s) to be matched against known templates in order to access private keys stored on a secure server before continuing transaction processing.

BioPKI protects an individual's biometric characterization so that it cannot be compromised or abused. This secured information is then used to retrieve a uniquely assigned private key that can only be accessed via a biometric signature to sign a transaction message context As a result, this new technology employing digital signatures, encryption and decryption (data scrambling and unscrambling) technologies and a comprehensive framework of policies and procedures provides important new advantages. These include the following: protecting privacy by ensuring that electronic communications are not intercepted and read by unauthorized persons; assuring the integrity of electronic communications by ensuring that they are not altered during transmission and that the private key used has been verified with a biometric signature prior to signing the message; verifying the identity of the parties involved in an electronic transmission so that no party involved in an electronic transaction can deny their involvement in the transaction. Moreover, BioPKI delivers these assurances through a simple process, transparent to the user.

As with conventional PKI's, Bio PKI 200 in this example implementation uses public key cryptography such as that based on PKCS to ensure the confidentiality of sensitive information or messages by using a mathematical algorithm, or key, to scramble (encrypt) data, and a related mathematical key to unscramble (decrypt) it. Accordingly, authorized users receive a PKdI client 220 including, for example, special encryption and biometric signature capturing hardware and software. A pair of keys is also created for authorized users for use in Bio PKI 200, one an accessible public key 204, and the other a private key 206. However, unlike conventional PKI's, the user's private key 204 is kept secret from the user and is stored on a secure server and only accessed after a valid biometric signature 208 has been authenticated. The keys in a key pair are mathematically related so that a message encrypted with sender's private key 206 can only be validated using the corresponding public key 204. An authorized user being a sender (e.g. a bank customer or employee) thus has his/her message (e.g. a funds transfer request) encrypted using his/her private key 206, and the intended recipient (e.g. a Bank) validates the message using public key 204. Public keys can be made freely available by being published, for example, in electronic directories.

As with conventional PKI's, certificate authority 202 is a main component of Bio PKI 200. It is a trusted third party responsible for issuing digital certificates 210 corresponding to authorized users and managing them throughout their lifetime. Differently from a conventional certificate authority, however, certificate authority 202 according to the invention further includes a PKdI server 212 that creates and manages the repository for the biometric templates and private keys associated with authorized users as will be described in more detail below.

PKdI server 212 is implemented by, for example, a server computer such as those provided by Sun, Hewlett Packard and the like, configured with Unix or similar operating system and network server functionality such as the public domain Apache server. Preferably, PKdI server 212 also includes Secure Software Layer protocol functionality for encryption/decryption of all communications with clients 220. According to an aspect of the invention, PKdI server 212 is maintained and operated by a trusted third-party separately from the service whose transactions are to be protected. It should be noted that PKdI server 212 can include hardware and software other than that described herein. However, such conventional componentry and functionality will not be described in more detail so as not to obscure the invention. Reference can also be made to co-pending application Ser. No. 09/801,468 (AWT-003) for the server functionality and implementations described therein.

Although described separately herein for case of illustration, it should be noted that certain of the components and functionalities of PKdI server 212 may be integrated within the web server or network of a transaction provider such as a financial institution. Those skilled in the art will understand the various alternatives after being taught by the present example, and such alternatives are to be considered additional embodiments of the invention.

Biometric signature 208 is comparable to a traditional identification check against an individual's drivers license, passport, etc. In one example implementation, fingerprint characterization technology such as that described in the co-pending application (AWT-003) is used to locate and encode distinctive characterizations from a biometric sample in order to generate a biometric signature template. Biometric comparison is thereafter done against the registered template for an individual in order to grant access to the individual's private key 206 for a transaction.

Digital Certificates 210 are electronic files containing, for example, the sender's public key 204 and specific identifying information about the sender. The digital certificates can be encrypted by the CA 202 and decrypted by recipients using the CA's public key 222 for verification of the certificate's contents. By using standard digital certificate generation, for example, they are made tamper-proof and cannot be forged, and are well trusted by the Internet community for data encryption/decryption of sensitive information. Much as a passport office does in issuing a passport, certificate authority 202 thus certifies that the individual granted the digital certificate is who he or she claims to be.

Digital Signature 214 is an electronic identifier comparable to a traditional, paper-based signature—it is unique, verifiable, and only the signer can initiate it. Used with either encrypted or unencrypted messages, a digital signature also ensures that the information contained in a digitally signed message or document was not altered during transmission.

PKdI client 220 includes biometric collection devices and associated software (e.g. fingerprint scanning and characterization, retinal scanning and characterization, etc.), as well as encryption/decryption software for communicating with PKdI server 212. To the extent not described in co-pending application Ser. No. 09/801,468 (AWT-003) and encryption/decryption, network communication technology and protocols known in the art (e.g. HTTPS, TCP/IP and SSL), the functionality and implementation details of PKdI client 220 will become apparent from the descriptions of PKdI server 212 below. It should be further noted that the particular computer device associated with PKdI client 220 is incidental to the present invention and can include such devices as PCs, laptops, notebooks, PDA's and other handheld devices, smart phones, etc.

Generally, the biometrics characterization features of the present invention provide the assurance that the individual is authenticated by means of undeniable characteristics, for example fingerprints, retinal scans, etc. According to an aspect of the invention, individuals need no longer maintain “tokens” containing their private information for every service to which they require access. Rather, such information can be generated and stored on PKdI server 212 for authorized users. Requests for a digital signature to be appended to a message are then authenticated using a biometric signature for the individual submitting the request. If the biometric signature submitted by the individual in conjunction with the request for a digital signature does not match the individual's stored template, the individual's private key 206 is not accessed and/or used for the request. This technique ensures that the user's own private key is not compromised by theft, and that the user is not burdened with having to possess instruments or passwords in order to initiate secure transactions. The only “token” thus required to be provided or maintained by the user is his/her own immutable characteristics, such as fingerprints, retinal scans or other biometric signatures as mentioned in the co-pending application.

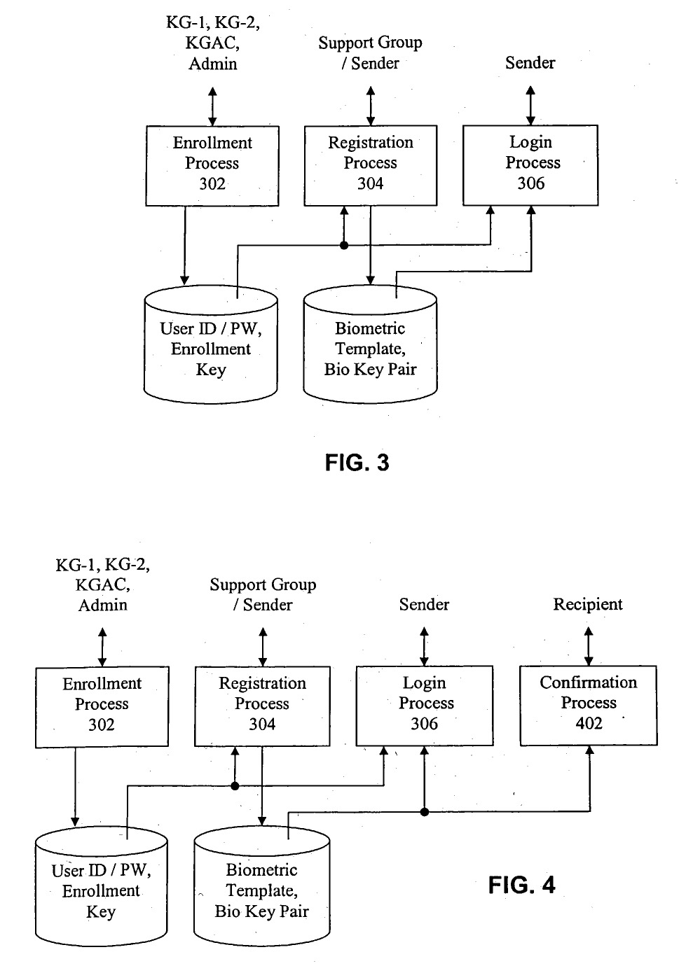

A block diagram illustrating an example implementation of PKdI server 212 in accordance with certain aspects of the invention is provided in FIG. 3.

As shown in FIG. 3, server 212 in this example includes an enrollment process 302 that will create two distinct pre-enrollment keys that are then provided to a different entity for generation of a final enrollment key for each individual seeking enrollment with the system. In one example implementation, the enrollment keys are unique and randomly generated alphanumeric strings that are at least 19 characters long. According to one example, enrollment process 302 requires a final enrollment key to be generated by one trusted individual using pre-enrollment keys generated by two other individuals, thus providing another layer of security and ensuring that enrollment of new users is not controlled by a single individual. It should be noted that enrollment can include other actions, such as the entry/generation of account information and other identifying information associated with the prospective user.

As further shown in FIG. 3, PKdI server 212 also includes registration process 304. Generally, registration process 304 allows individuals to register with the BioPKI server 212. During the registration process, a trusted individual associated with the third party configures the prospective user with a PKdI client 220 and supervises the user's entry of the account ID, password, and enrollment key via the client. The trusted individual also preferably ensures that the person actually entering the ID, password, enrollment key and biometric sample is the “Named” enrollee.

After PKdI server 212 has validated the account ID, password and BioPKI enrollment key entered by the enrollee, the enrollee is then required to submit a biometric signature 208 for creation of a biometric template. After receipt of a “verified” biometric template, PKdI server 212 generates a private and a public key 204, 206 (i.e. key pair) for the enrollee.

After the enrollee has been successfully registered with PKdI server 212, he/she will thereafter be redirected to the login page or specified location for normal transaction processing. Login process 306 maintains the login page. Generally, the login process authenticates the sender's biometric signature 208 prior to allowing access to the sender's private key 206 for creating a digital signature 214 for transactions that require a digital signature.

As mentioned above, among many advantages, this eliminates the need for the individual having to carry several “tokens” for specific applications. These can instead be stored on the server 212 along with domain and used only when all verification and biometric signature procedures have taken place.

Login process 306 then performs biometric authentication for the individual using the biometric template corresponding to the entered User ID and Password stored in the BioPKI server. For example, login process 306 causes the PKdI client 220 to collect a biometric signature from the individual. The collected biometric signature 208 is then compared with the stored biometric template. Upon validation of the collected biometric signature 208, a redirect to the appropriate application or page can be conducted. For example, the BioPKI can have the ability to forward the authenticated requests to an Account and Password system associated with the requested service for verification and retrieval of permission information associated with the individual. If the biometric signature 208 does not match the stored template, the individual can be redirected to a designated page for biometric failures. An example of how a “match” can be determined is provided in the co-pending application (AWT-003).

In one example implementation, BioPKI utilizes PKCS technology to encrypt the biometric signature 208 information for transmission to the PKdI server 212. The encryption packet can further contain several layers of internal information, to ensure that a packet has not been compromised during transmission, or at the origination point. For example, when PKdI server 212 receives a request for biometric authentication, the server assigns a unique transaction ID to the request that becomes part of the encryption/decryption process. As a result, no two identical transactions may be created, nor will they be accepted by the BioPKI system.

When the PKdI server 212 receives the biometric packet, it checks the integrity of each component of the packet. The biometric signature is self-protecting, by using uniquely generated, one time Private-Public Key pairs for all transaction requests. Generation of these key pairs is deployed using standard PKCS technologies, and ensures that each transaction request is unique. This implementation ensures that “cutting and pasting” of biometric data is not possible, since each session request to the user is randomly generated by the PKdI server, and ensures unique encryption at each point in the transaction. The entire session request is then doubly encrypted through standard SSL protocols. Integrity checks that are in addition to the session's Private-Public pair can be made to ensure that the biometric signature has not been tampered with, including cutting/pasting hacks. These additional checks can include an IP address stamp (validating the Internet address of the target client in both directions), as well as a time stamp and/or the unique transaction ID. If any of the integrity checks fail, the biometric request is considered invalid and the request is aborted. Depending upon the nature of the transaction flow, the individual may be redirected to another network location, such as an error or original login page.

FIG. 4 illustrates an alternative implementation of a PKdI server in accordance with the invention. As shown in FIG. 4, the server in this example further includes confirmation process 402.

The transaction confirmation pages of an organization's (e.g. financial institution) website can be modified so that upon clicking on a “submit” button for an electronic transaction, for example, a request is forwarded to the PKdI server using known re-direction techniques for a biometrics confirmation. The PKdI server 212 then establishes a link with the sender and invokes the PKdI Client 220.

The sender's User Id is used to locate the biometric template and the associated private key 206. The PKdI client 220 then collects the individual's biometric signature 208. If biometric authentication is successful, the private key 206 associated with the biometric signature 208 is retrieved and used to sign the message context. The digital signature associated with the transaction request and encrypted with the private key 206 is then forwarded downstream for processing by the recipient. If a biometric signature fails to match the requestor's stored biometric template, the private key is not accessed and the message is not signed. A message is considered “unsigned” until the private key has been validated using the individual's biometric signature.

Further verification to strengthen the digital signature can be requested by the recipient and/or sender, which verification can also be performed in another example implementation of confirmation process 402. For example, the recipient or sender can request an additional biometric signature comparison against the individual's template. Biometric signatures are captured and maintained in a database for each transaction that is signed with a private key for a specified period. The captured biometric signature 208 that was used to provide access to the private key can be further incorporated as part of the message that the recipient receives for this authentication process. This provides double verification: using the individual's biometric signature 208 to access the private key 206, as well as including the actual biometric signature that was used to sign the message in the message itself and comparing that received biometric signature with the stored template.

It should be noted that confirmation process 402 can include either or both of the above biometric verification functionalities.

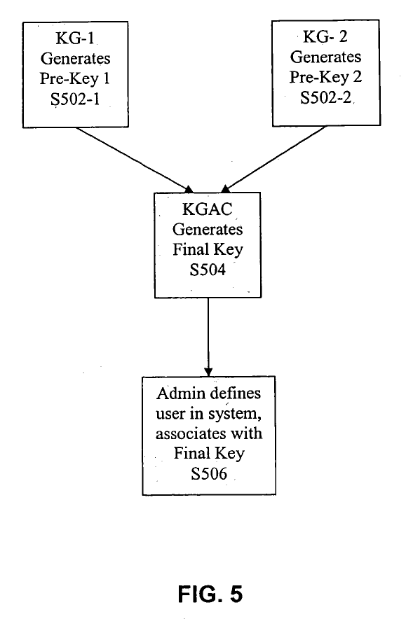

FIG. 5 is a flowchart depicting an example method that can be implemented by the enrollment process of the PKdI server according to the invention.

According to one aspect of the invention, the process protects the enrollment key generation process by requiring the participation of more than one individual. The following steps can be taken to ensure that the creation of the BioPKI enrollment key is secure and certifiable. It should be understood that the enrollment process may only be initiated once a user's application has been fully verified and approved by the entity (e.g. financial institution) hosting the service to which the user (e.g. bank customer/employee) will gain access.

As shown in steps S502-1 and S502-2, two authorized employees (Key-Generator-1 and Key-Generator-2)/ (KG-1 and KG-2) from the service will access the enrollment process and provide the enrollment process with the user's identifying information. The enrollment process then generates respective pre-enrollment keys and communicates them to the employees. In one example, the pre-enrollment keys are unique and randomly generated alphanumeric strings. Preferably, KG-1 and KG-2 will access the enrollment process separately to generate the pre-enrollment keys for every approved user/client.

KG-1 and KG-2 will then forward the pre-enrollment keys to the Key Generator Administrator and Certifier (KGAC) for generating and approval of the final enrollment key. An authorized employee from the organization will be the KGAC. After the KGAC has entered prospective user's identifying information, the enrollment process will prompt KGAC for the two pre-enrollment keys already generated for the user. If this information is correct, the enrollment process will produce the final enrollment key, and if required, can further require a biometric signature to be supplied by the KGAC (S504). In one example, a proprietary program is used to generate the final enrollment key.

In step S506, the KGAC will then forward an instruction to the BioPKI administrator to define the user (e.g. generate a User ID) and issue a default/temporary password to be associated with the matching final enrollment key. In one example, this is done by a certified document forwarded to the BioPKI administrator. Such certified document will contain the User ID, default/temporary password and final enrollment key, among other possible identifying information. The BioPKI administrator will then enter such information into the BioPKI system in preparation for enrollment of the accredited client/user and collection of the biometric data, as set forth in more detail below.

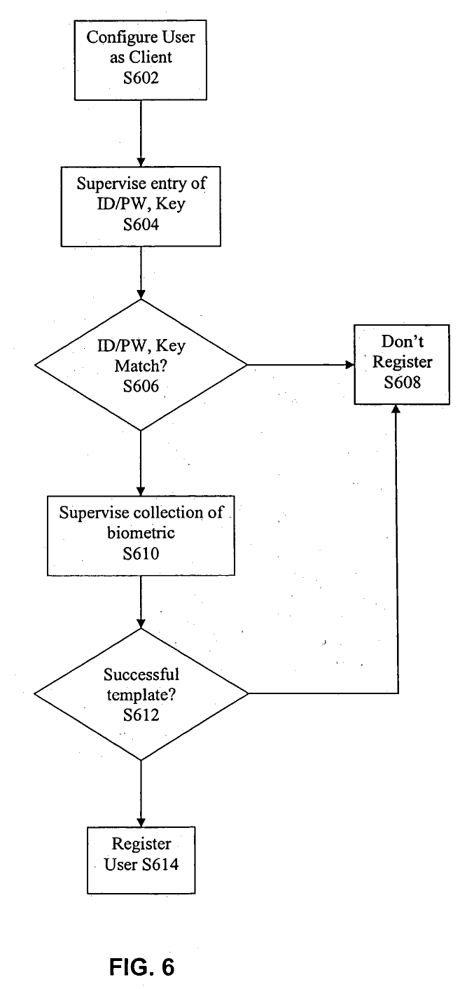

FIG. 6 is a flowchart depicting an example method that can be implemented by the registration process of the PKdI server according to the invention.

In one example, after the BioPKI administrator enters the user's information in the system, an after-sales support group will then be given the certified final enrollment key. A trusted individual in the after-sales support group will then configure the prospective user with a client for accessing and communicating with the PDkI server. For example, the support group will install BioPKI client software and a biometric scanner on the client's workstation (step S602).

After installation, the user will use the client software to login to the BioPKI system using the User ID, Password and Final-Enrollment-Key provided by the after-sales support group (step S604). If this entered information does not match the stored information, the registration process will not register the user and processing will end (step S608). Otherwise, the user will then be prompted to enter a biometric for collection. Preferably, the collection of the biometric will be personally supervised by the support group individual to ensure that the named user is the actual person supplying the biometric sample (e.g. a fingerprint scan) (step S610).

If the collection of the biometric sample results in the successful creation of a biometric template (as determined in step S612), the user will be registered with the system. The user at this point can change his/her default/temporary system password. In one example implementation, registration includes generating a public/private key pair for the user and creating a digital certificate containing the user's identification information and the user's public key. This digital certificate is then provided to the service (e.g. financial institution) with which this user is intending to register so that the service can obtain the user's public key for subsequent communications.

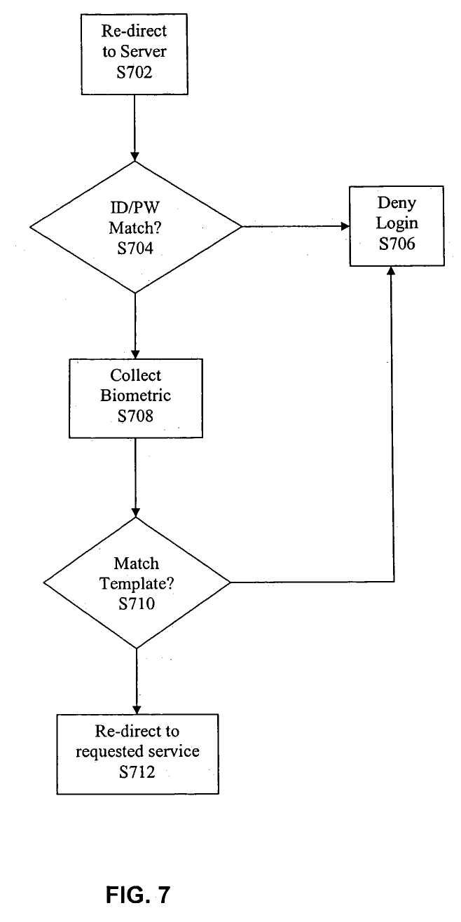

FIG. 7 is a flowchart depicting an example method that can be implemented by the login process of the PKdI server according to the invention.

In one example, a service that has a contract with the BioPKI system of the invention (i.e., certificate authority 202, preferably a trusted third party) will have a login screen before access to the service is granted to a requesting user. Associated with the login screen will be a script to launch the login process of the PKdI server. Once a requesting user enters a User ID and Password, the information will be forwarded to the login process 306 of the BioPKI server (step S702). If the User ID and password match-(determined in step S704, the user's biometric template will be retrieved and the user will be further requested to supply a biometric signature (step S708). If the biometric signature compares favorably against the stored template for that user, a redirect to the appropriate application or page is conducted. For example, the BioPKI can forward the authenticated requests to an Account and Password system in the requested service for verification and permissions granted to the user. If the login or biometric signature does not match, the individual will be redirected to the designated page for biometric failures and denied access to the requested service (S706).

As explained more fully above, BioPKI can utilize PKCS technology to encrypt the biometric signature information for transmission to the PKdI server. The encryption packet can further contain several layers of internal information, used to ensure that a packet has not been compromised during transmission, or at the origination point. When the PKdI server receives a request for biometric authentication, the server assigns a unique transaction ID to the request that becomes part of the encryption/decryption process. As a result, no two identical transactions may be created, nor will they be accepted by the BioPKI system. Other internal verifications can include IP stamp and a time stamp.

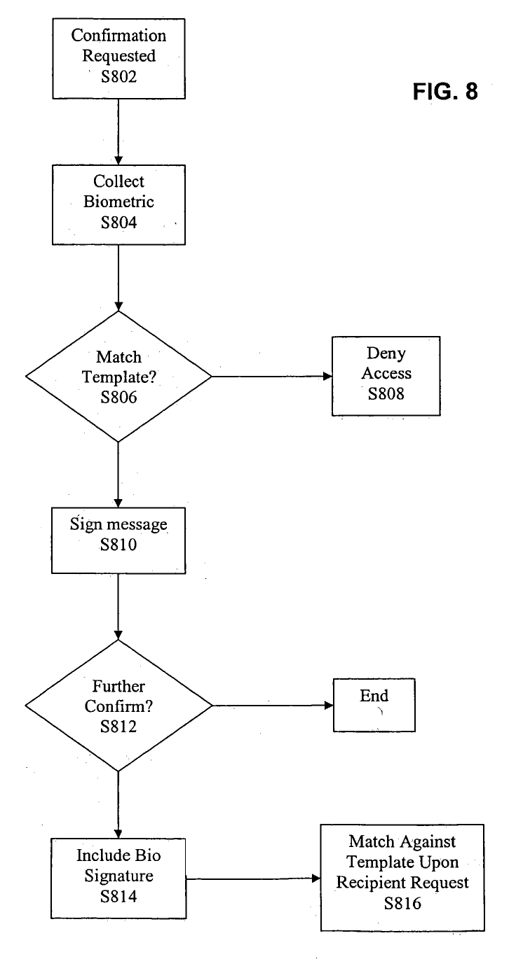

FIG. 8 is a flowchart depicting an example method that can be implemented by the confirmation process of the PKdI server according to the invention.

If confirmation of a user transaction is requested, the request is forwarded to the PKdI server using known re-direction techniques, for example, for a biometrics confirmation (step S802). The PKdI server 212 then establishes a link with the sender and invokes the PKdI client software for collection and transmission of the user's biometric signature (step S804).

The sender's User Id is used to locate the biometric template for comparison (step S806). If the biometric authentication is successful, the private key 206 associated with the user is retrieved and used to sign the Message Context. The digital signature is then appended to the message to the service/recipient. If a biometric signature comparison fails, the private key is not accessed and the message is not signed (step S808). At this point, the recipient can confirm the user's access simply by decrypting the digital signature.

However, additional verification to strengthen the digital signature can be made by requesting a biometric signature comparison against the individual's template. Whether this is desired (requested either by the sender of the recipient) is determined in step S812. The biometric signatures captured in step S804 can be maintained in a database for each transaction that is signed with a bio private key for a specified period. If further confirmation is needed, the biometric signature itself can be incorporated as part of the message that the recipient receives for this authentication process (step S814). This provides a double verification process using the individual's private key as well as the actual signature that was used to sign the message. Accordingly, upon the recipient's request, the confirmation process can provide a verification that the forwarded biometric signature successfully compares against the sender's stored template.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications.

What is claimed is:

1. A method comprising:
receiving a request for access to a service;
collecting a biometric sample from a user associated with the request;
comparing the biometric sample to a biometric template associated with the user; and
providing access to a private key in accordance with a result of the comparing step.

2. A method according to claim 1, further comprising:
if the result indicates a match, generating a digital signature using the private key to the user.

3. A method according to claim 2, further comprising:
providing the digital signature to the service associated with the request.

4. A method according to claim 1, further comprising:
providing a biometric signature corresponding to the collected biometric sample to the service associated with the request.

5. A method according to claim 4, further comprising:
allowing the service to determine whether to fulfill a transaction corresponding to the request in accordance with the result of the comparing step.

6. A method according to claim 1, further comprising:
generating pre-enrollment keys for the user;
supplying the pre-enrollment keys to respective key generators; and
generating a final enrollment key for the user only if keys provided by a key administrator match the pre-enrollment keys supplied to the key generators, the key administrator being a person different than the key generators.

7. A method according to claim 6, further comprising:
verifying registration of the user in accordance with a comparison of the final enrollment key;
creating the biometric template for the user only if registration is verified; and
generating the private key only if the biometric template is successfully created.

8. A method according to claim 6, further comprising associating user identification information with the final enrollment key.

9. A method according to claim 1, further comprising:
encrypting the collected biometric sample for transmission to an authentication server; and
including integrity information in the encrypted biometric sample.

10. A method according to claim 9, further comprising:
decrypting the encrypted biometric sample at the authentication server; and
checking the integrity information included with the biometric sample.

11. A method according to claim 9, wherein the integrity information includes a unique transaction identifier.

12. A method according to claim 1, further comprising:
associating user identification information with the private key; and
maintaining a digital certificate containing the user identification information and a public key corresponding to the private key.

13. A method according to claim 1, wherein the biometric sample includes a fingerprint scan.

14. An apparatus comprising:
means for receiving a request for access to a service;
means for collecting a biometric sample from a user associated with the request;
means for comparing the biometric sample to a biometric template associated with the user; and
means for providing access to a private key in accordance with a result of the comparing step.

15. An apparatus according to claim 14, further comprising:
if the result indicates a match, means for generating a digital signature using the private key to the user.

16. An apparatus according to claim 15, further comprising:
means for providing the digital signature to the service associated with the request.

17. An apparatus according to claim 14, further comprising:
means for providing a biometric signature corresponding to the collected biometric sample to the service associated with the request.

18. An apparatus according to claim 17, further comprising:
means for allowing the service to determine whether to fulfill a transaction corresponding to the request in accordance with a result of the comparing means.

19. An apparatus according to claim 14, further comprising:
means for generating pre-enrollment keys for the user;
means for supplying the pre-enrollment keys to respective key generators; and
means for generating a final enrollment key for the user only if keys provided by a key administrator match the pre-enrollment keys supplied to the key generators, the key administrator being a person different than the key generators.

20. An apparatus according to claim 19, further comprising:
means for verifying registration of the user in accordance with a comparison of the final enrollment key;
means for creating the biometric template for the user only if registration is verified; and
means for generating the private key only if the biometric template is successfully created.

21. An apparatus according to claim 19, further comprising means for associating user identification information with the final enrollment key.

22. An apparatus according to claim 14, further comprising:
means for encrypting the collected biometric sample for transmission to an authentication server; and
means for including integrity information in the encrypted biometric sample.

23. An apparatus according to claim 22, further comprising:
means for decrypting the encrypted biometric sample at the authentication server; and
means for checking the integrity information included with the biometric sample.

24. An apparatus according to claim 22, wherein the integrity information includes a unique transaction identifier.

25. An apparatus according to claim 14, further comprising:
means for associating user identification information with the private key; and
means for maintaining a digital certificate containing the user identification information and a public key corresponding to the private key.

26. An apparatus according to claim 14, wherein the biometric sample includes a fingerprint scan.

27. An authentication infrastructure comprising:
a server that intercepts requests for access to a service; and
a client that collects a biometric sample from a user associated with the request,
wherein the server maintains a biometric template associated with the user for authenticating the collected biometric sample, and
wherein the server provides access to a private key in accordance with a result of the authentication, so that the user need not maintain a token for accessing the service.

28. An authentication infrastructure according to claim 27, wherein the private key is used to sign a message for allowing the user to perform a transaction with the service, the service obtaining a corresponding public key from the server.
